(19) United States
(12) Patent Application Publication
(10) Pub. No.: US 2015/0320038 A1
(43) Pub. Date: Nov. 12, 2015

(54) Hand Sanitizer with Soft Focus Effect on the Skin

(71) Applicant: Garden Art Innovations, LLC, Akron, OH (US)

(72) Inventor: William Joseph Marthaler, HUDSON, OH (US)

(73) Assignee: Garden Art Innovations, LLC, Akron, OH (US)

(21) Appl. No.: 14/193,288

(22) Filed: Feb. 28, 2014

Related U.S. Application Data
(60) Provisional application No. 61/771,108, filed on Mar. 1, 2013.

(51) Int. Cl. A01N 25/32; A01N 31/02

(52) U.S. Cl. CPC A01N 25/32; A01N 31/02

(57) ABSTRACT

This invention discloses a high alcohol content antimicrobial gel composition for disinfecting the hands, having a soft focus effect (line blurring of visual skin imperfections) on the skin.

### TECHNICAL FIELD

The invention relates to an antimicrobial alcoholic gel composition fbr disinfecting the hands, which provides a soft focus effect on the skin.

### BACKGROUND ART

Alcoholic gel compositions are commercially available and are known to be useful in disinfecting skin.

These compositions are known to dry the skin, so some contain oils and materials to condition the skin.

### SUMMARY

The object of the present invention is to provide a high alcohol content gel composition for frequent use that provides a soft focus effect on the skin. This soft focus line blurring effect makes the hands look younger.

### DETAILED DESCRIPTION

The gel compositions comprise from about 0.1% to about 5% of a soft focus effect silicone powder, which can be vinyl dimethicone/methicone silsesquioxane cross polymer, about 50% to about 90% ethanol or isopropanol, about 0.2% to about 2 of a thickening agent, which can be an addition polymer of acrylic acid crosslinked with an unsaturated poly-functional agent, sufficient neutralizing agent, such as aminomethylpropariol, to neutralize carboxyl groups in the thickener, and about 0.2% to about 2.5% of a natural emollient, such as castor oil, wherein there is at least about 20% water, and the gel. composition has a viscosity of from about 5,000 centipoise to about 100,000 centipoise at 25° C.

### Example 1

Example 1 illustrates the production of the composition.

SD Alcohol 40A-64.0%

Ultrez 20 Carbomer-0.4%

Vinyl dimethiconelmethicone silsesquioxane cross polymer-0.5%

Grape see oil-0.5%

Jojoba oil-0.5%

Sunflower oil-0.5%

Castor oil-0.5%

Aminomethylpropanol-0.1%

Fragrance-0.8%

Deionized water- 32.2%

The pH is 7.0 to 8.0 and the viscosity is between 20,000 to 50,000 centipoise.

The invention was described above based on an exemplary embodiment. It goes without saying that numerous modifications and variations of the invention are possible without abandoning the underlying inventive idea. All of the percentages used are weight percent.

1. (canceled)

2. (canceled)

3. A gel composition comprising:
vinyl dimethicone/methicone silsesquioxane crosspolymer;
an alcohol;
a thickening agent;
a neutralizing agent;
at least one hydrocarbon emollient; and,
water.

4. The composition of claim 3, wherein the alcohol is ethanol or isopropanol.

5. The composition of claim 3, wherein the thickening agent is an addition polymer of acrylic acid crosslinked with an unsaturated polyfunctional agent.

6. The composition of claim 3, wherein the hydrocarbon emollient is chosen from the group consisting of castor oil, grape seed oil, sunflower oil, and jojoba oil.

7. The composition of claim 3, wherein the crosspolymer is about 0.1% to about 5% by weight.

8. The composition of claim 7, wherein the alcohol is ethanol or isopropanol and is about 60% to about 75% by weight.

9. The composition of claim 8, wherein the thickening agent is an addition polymer of acrylic acid crosslinked with an unsaturated polyfunctional agent, wherein the thickening agent is about 0.2% to about 2% by weight.

10. The composition of claim 9, wherein the neutralizing agent is an amount sufficient to neutralize carboxyl groups in the thickening agent.

11. The composition of claim 10, wherein the hydrocarbon emollient is chosen from the group consisting of castor oil, grape seed oil, sunflower oil, and jojoba oil, wherein the emollient is about 0.2% to about 2.5% by weight.

12. The composition of claim 11, wherein the water is about 20% by weight.

13. The composition of claim 10, wherein the neutralizing agent is aminomethylpropanol.

14. A gel composition comprising:
64% by weight alcohol;
0.4% by weight carbomer;
0.5% by weight vinyl dimethicone/methicone silsesquioxane crosspolymer;
0.5% by weight grapeseed oil;
0.5% by weight jojoba oil;
0.5% by weight sunflower oil;
0.5% by weight castor oil;
0.1% by weight aminomethylpropanol;
0.6% by weight fragance; and,
32.2% by weight deionized water.
